(19) United States
(12) Patent Application Publication
(10) Pub. No.: US 2026/0178114 A1
(43) Pub. Date: Jun. 25, 2026

(54) SYSTEM AND PROCESS OF PHYSICAL INTERACTION BETWEEN TWO USERS IN AN AUGMENTED REALITY

(71) Applicant: UNIVERSITA' DEGLI STUDI DI SIENA, Siena (IT)

(72) Inventors: Domenico PRATTICHIZZO, Siena (IT); Alberto VILLANI, Giugliano in Campania (Napoli) (IT); Tommaso LISINI BALDI, Siena (IT); Nicole D'AURIZIO, Monteroni D'Arbia (Siena) (IT)

(21) Appl. No.: 19/122,281

(22) PCT Filed: Oct. 18, 2023
(86) PCT No.: PCT/IB2023/060522

§ 371 Date: Apr. 18, 2025

(30) Foreign Application Priority Data
Oct. 18, 2022 (IT) 102022000021405

(51) Int. Cl. G06F 3/01; G06F 3/04815

(52) U.S. Cl. CPC G06F 3/011; G06F 3/016; G06F 3/04815

(57) ABSTRACT

A system of physical interaction between two users in an augmented reality. The system includes a display device provided with a camera and a processing unit, adapted to be worn by a first user, and a manipulator device adapted to perform a mechanical manipulation controlled by a second user when the first user is located in and environment with said manipulator device. The processing unit is configured to project, to the first user, a stream of digital images representative of a fusion of at least one virtual image of augmented reality and at least one real image of the environment. The processing unit is configured to remove from said stream of digital images, during said mechanical manipulation, portions of the at least one real image corresponding to the manipulator device and replace them with the image of a virtual hand of said second user.

### FIELD OF APPLICATION

The present invention relates to a system and a process of physical interaction between two users in an augmented reality.

In particular, the present invention relates to a system and a process of physical interaction between two users in an augmented reality wherein a first user wears a display device and a second user controls a mechanical manipulation by means of a manipulator device.

### PRIOR ART

In recent years, many forms of virtual interaction have been developed for users. Two examples are augmented reality (AR) and virtual reality (VR).

The term “virtual reality” refers to a computer-generated environment that the user can experience through sensorial stimuli, such as sight and sound. In virtual reality, a user can explore a completely virtual environment and can interact with other users present in the same virtual environment in the form of digital representations (avatars).

The term “augmented reality” refers to a computer-generated augmentation of a real environment of the user, which the user can experience through sensorial stimuli, such as sight and sound. In augmented reality the user displays, by means of a screen, a digital image overlaid on the image of a real environment in which he or she is located and sees through the same screen.

In augmented reality, the user usually wears a display device such as a headset, or a mask or a visor, which enables him or her to display the overlay of the real environment in which he or she is and the digital image, and/or hear sounds coming from the real environment.

The display device is usually provided with at least one camera that projects towards the user's eyes, via a processing unit of the camera itself, an overlay of images of the real environment in which the user is located, acquired by the camera, and digital images generated by the processing unit.

In the augmented reality applications of the above-described type, remote users are connected to each other in a real “augmented” environment by virtue of the possibility of seeing each other reciprocally and of also seeing the digital image overlaid on the real environment. The interactions between the users and/or with the environment surrounding them are thus assisted by a layering of levels of virtual reality and augmented reality: the users can meet each other, interact, and share their ideas in an active and dynamic dialogue, overcoming the limits of teleconferencing systems.

However, a problem of the known systems is the fact that the interaction between the users is only verbal or visual and involves no physical interaction with the environment through touch or the manipulation of objects in the environment in which said users are located.

Pouring a hot drink into a cup, handing over a book, or writing down a thought on a shared paper draft are all forms of interaction between users that cannot be transmitted remotely with the current teleconferencing systems.

In the past decade, research in the field of haptic interaction has demonstrated that it is possible to improve the experience of enjoying a virtual or virtualised environment; however, though involvement, attention and expressive capacities increase through robotic solutions, the tactile interaction between users and with the objects around them is often dehumanised and/or forced.

FIG. 1 shows a system of physical interaction in which a user 1 is wearing a display device 2 and is located in an environment in which there is a manipulator device 4, such as a robotic manipulator arm, adapted to perform a mechanical manipulation. In particular, the robotic manipulator arm is configured to pick up and manipulate an object 6 in relation to the user 1.

If the user 1 is looking at an augmented reality associated with said environment using the display device 2, he or she will in any case see the image of the robotic manipulator arm 4.

A first object of the present invention is thus to propose a system and a process of physical interaction between two users in an augmented reality that enables the users to manipulate objects and physically interact with each other by means of a manipulator device without seeing the manipulator device that carries out that manipulation and/or physical interaction, thereby overcoming the problems of the prior art listed above.

U.S. Pat. No. 10,362,299 B1, which deals with a system for introducing physical experiences into worlds of virtual reality, is known.

In particular, U.S. Pat. No. 10,362,299 B1 deals with a use of a robotic manipulator to align physical and virtual reality so as to enhance the tactile experience of an individual user.

The description is concentrated primarily on virtual environments that are completely overlaid on the real world and the robotic manipulator is mainly used to align virtual entities with physical objects with the aim of improving the tactile experience of the individual user. This suggests a focus on the use of a robot as an instrument for amplifying the tactile perception of the individual user, but might not enable a direct, precise control over real objects.

Furthermore, the manipulator and the user are simultaneously in contact with the same object in order to replicate the kinaesthetic perception of the hand-object interaction.

Patent US 2021/0086364 A1, which deals with a teleoperation based on the vision of a robotic system, is also known.

In particular, US 2021/0086364 A1 deals with a method of controlling grippers and robotic arms through an analysis of human postures acquired through the use of optical sensors and processing algorithms.

It describes a strategy for acquiring and analysing the postures of the human hand with the aim of effectively reproducing them in a robotic gripper that reproduces the features and mobility of the human hand, with the aim of controlling an anthropomorphic or semi-anthropomorphic gripper.

### SUMMARY OF THE INVENTION

The general object of the present invention is to overcome or limit the drawbacks of the prior art.

The first object mentioned above and other objects are achieved with a system of physical interaction between two users in an augmented reality whose features are defined in claim 1, and with a process of physical interaction between two users in an augmented reality whose features are defined in claim 5.

Particular embodiments form the subject matter of the dependent claims, whose content is to be understand as an integral part of the present description.

The invention achieves a plurality of technical effects/functional and constructive advantages.

In particular, at least compared to U.S. Pat. No. 10,362,299 B1,
the solution described is geared towards a collaborative activity between users mediated by layers of augmented reality for the sharing of spaces, and the use of manipulators for the rendering of actions in physical space;
the solution described envisages a use of augmented reality that fuses the virtual with the real; this makes it possible to influence the user's perception and poses further challenges tied to the fusion of the real and virtual worlds, such as the recognition of real objects, calibration and management of overlaid information;
the solution described envisages a masking and overlay technique for rendering the technical effect of embodiment and realism so as to ensure that the user's hand and the robotic manipulator are realistically integrated in the virtual and physical environment;
the solution described envisages that there is no simultaneous manipulation by the user and robot on the same object; in other words, it is not envisaged that the user and robot will come into contact with each other through the object;
the solution described envisages that combining the control of the manipulator and masking by overlay of a virtual hand avatar will make it possible to obtain a technical effect of embodiment and perception of realism for both users. This means that both users can feel themselves completely immersed in the virtual and physical environment, with a sensation of direct control over real objects and a realistic perception of the overlaid virtual hand.

In short, the present invention differs from the prior art U.S. Pat. No. 10,362,299 B1, at least because of the:
direct control of the robotic manipulator by the user;
masking by overlay of a virtual hand avatar and sharing of physical space between the users and the manipulator.

According to the present invention, these features are inseparable from a technological standpoint, and from the standpoint of the resulting technical effect, which is to create an experience of interaction and advanced collaboration that goes beyond the aim of improving the tactile experience and offers greater precision and realism in remote human-to-human interaction assisted through robotics and AR environments.

The invention achieves a plurality of technical effects/functional and constructive advantages.

In particular, at least compared to US 2021/0086364 A1,
the solution described envisages that there are no limits regarding the features of the gripper or its resemblance to the human hand. One the contrary, emphasis is laid on the ability of the gripper to effectively grasp the object subjected to manipulation in the environment of the second user, according to the wishes of the first.
By way of non-limiting example, the gripper could perform the gripping action through the use of different technologies, such as pneumatic, hydraulic or magnetic.
the solution described envisages that the control of the gripper is based not on the exact replication of the posture of the human hand, but rather on the reproduction of the effects at the centre of mass of the manipulated object. This means that the robotic manipulator has the flexibility of choosing the optimal grip based on various factors, such as the shape, size, and solidity of the object, as well as operator quality criteria such as firmness of the grip, manipulability of the arm and exposure in cameras, parameters given by way of example and not limiting other possible parameters of manipulation efficacy.
the solution described envisages that the manipulator, based on what has been said, though teleoperated, maintains autonomy in the choice of pose preceding the grip in order to grasp the object in the best manner with respect to the specific criteria identified for the assigned task.

In short, the present invention differs from the prior art US 2021/0086364 A1 at least because of the:
absence of a precise analysis of the posture of the human hand;
reproduction of the effects at the centre of mass of the manipulated objects, thus offering a different flexibility and adaptability in the manipulation environment and to the gripper, also, but not only, allowing the optimisation of manipulation performances.

### BRIEF DESCRIPTION OF THE DRAWINGS

Additional features and advantages of the invention will become apparent from the detailed description that follows, provided purely by way of non-limiting example, with reference to the appended drawings, in which:

FIG. 1 shows a system of physical interaction of a user according to the prior art; and

FIG. 2 shows a system of physical interaction of a user according to the present invention.

FIG. 2 shows a system of physical interaction between two users in an augmented reality according to the present invention.

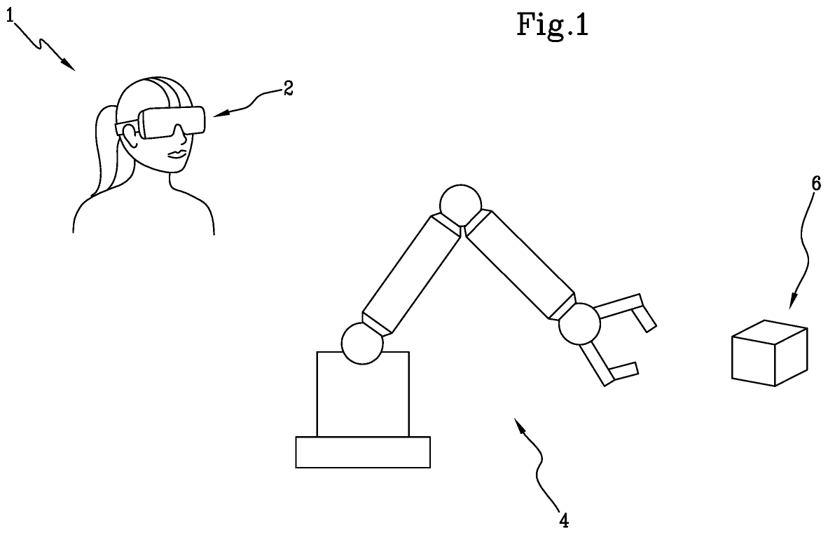

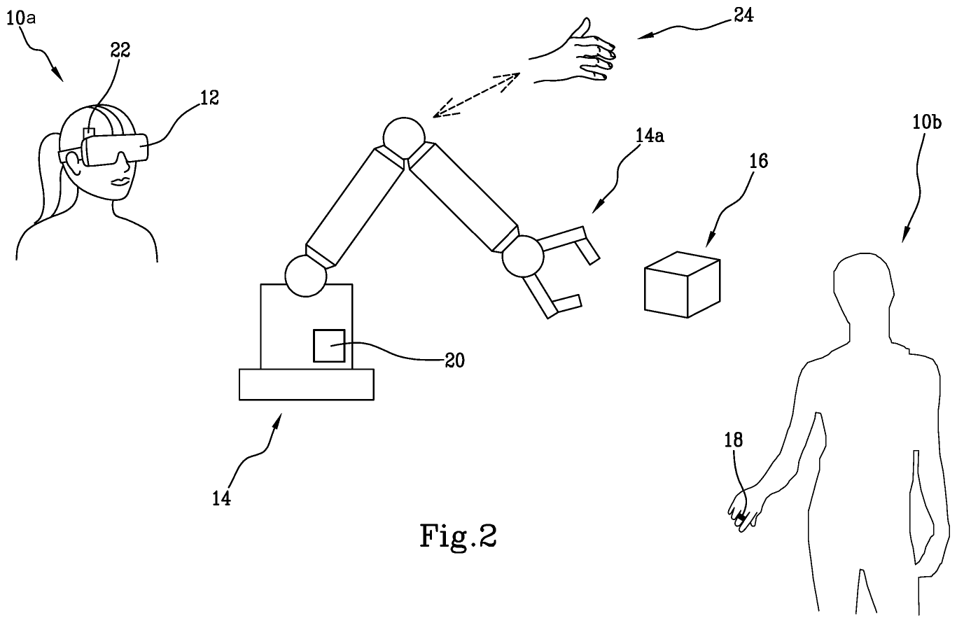

### DETAILED DESCRIPTION

This system of physical interaction makes it possible to obtain a physical interaction within an augmented reality and will be defined hereinafter in the description as a physical metaverse system.

In the system of physical interaction of the present invention, a first user 10 wears a display device 12, such as a visor provided with a camera.

The first user 10a is in an environment in which a manipulator device 14 is present (thus in the same environment), such as a robotic arm provided with a mechanical gripping device 14a, adapted to perform a mechanical manipulation which is controlled, as detailed below, by a second user 10b. In particular, the robotic manipulator arm 14 is configured to pick up and manipulate an object 16, in relation to the first user 10a.

Advantageously, the second user 10b wears at least one haptic feedback device 18, such as, for example, a ring fitted onto a finger of a hand, configured to receive at least one response signal from a processing unit 20 of the manipulator device 14.

The display device 12 comprises, in a manner known per se, a processing unit 22 that is configured to project towards the eyes of the first user 10a a stream of digital images representative of the fusion of at least one virtual image and at least one real image of the environment surrounding the first user 10a. Said stream of digital images comprises a digital representation of the object 16.

The processing unit 22 is further configured to remove, in a manner known per se, from said stream of digital images, the images of the manipulator device 14 during a mechanical manipulation, and replace them with the image of a virtual hand 240 of the second user 10b, who is located remotely from the first user 10a and is interacting with said first user 10a as specified here below.

If the first user 10a interacts in an augmented reality with the second user 10b, and the second user 10b operates the manipulator device 14 so as to interact physically with the first user 10a by means of a mechanical manipulation, for example by picking up the object 16 in order to hand it over to the first user 10a, the first user 10a does not see the manipulator device 14, but rather sees the image or digital representation of the hand 24 of the second user 10b.

In particular, the manipulator device 14 is controlled and operated in a manner known per se by the processing unit 20, which is configured to receive, from the second user 10b, position signals representative of position coordinates of the second user 10b in a predetermined reference system, and to operate the manipulator device 14 so as to exactly reproduce the position of said second user 10b. Preferably, the position of an arm and hand of said second user 10b is reproduced.

A tracking system, known per se, is associated with the second user 10b and is configured to identify the posture and movements of the second user 10b (preferably, of an arm and hand thereof) relative to the reference system, and to generate corresponding position signals to be transmitted to the processing unit 20 of the manipulator device 14.

The processing unit 20 of the manipulator device 14 is configured to process said position signals, in a manner known per se, and to obtain respective movement signals with which to operate the manipulator device 14 so as to cause to manipulator device 14 to carry out movements corresponding to the movements carried out by the second user 10b.

Thanks to the replacement, in the stream of digital images, of the images of the manipulator device 14, during the mechanical manipulation, with the image of the virtual hand 24 of the second user 10b, the interaction between the two users becomes much more natural.

The physical metaverse system described above is thus configured to carry out, via the processing unit 22 of the display device 12, a process of interaction between two users in an augmented reality, wherein a plurality of program modules (set of algorithms such as, for example, Chroma keying algorithms) is executed to conceal the manipulator device 14 from the first user 10a, during the mechanical manipulation, and replace it with a digital representation of the hand 24 of the second user 10b.

In this manner, the interaction between the two users is not rendered unnatural.

The system and process according to the present invention are thus based on digitally removing, from the stream of digital images that reach the eyes of the first user 10a from the display device 12, portions of the at least one real image corresponding to the manipulator device 14 in movement and replacing them with the avatar of the hand of the second user 10b.

The same effects at the centre of mass of the object 16 are subsequently induced on the virtual object corresponding to the object 16 manipulated in reality (digital representation of the object 16), in a manner known per se. For this purpose, image processing and machine learning techniques known per se are integrated for the recognition and deletion, from the stream of digital images, of the images of the manipulator device 14 in movement. Similarly, the theory of grasping and mapping of the forces applied on the object 16 are applied on the digital representation of the object 16 for a realistic, faithful reconstruction, in the augmented reality, of the forces and twisting due to contact manifested on the real object 16.

Advantageously, the processing unit 20 of the manipulator device 14 is further configured to send to the haptic feedback device 18 said at least one response signal representative of the manipulator device 14 manifested during the mechanical manipulation.

In this manner, the second user 10b is able to perceive a tactile sensation related to the real movement of mechanical manipulation performed by the manipulator device 14, so as to modify it according to a desired optimal movement.

Technologically, the technique of deleting the manipulator and the direct control thereof by the second user are not separable: it is necessary to use the position information of the robot in order to juxtapose the virtual hand thereupon and at the same time it is necessary to measure the posture and configuration of the second user's hand in order to generate appropriate control signals to the manipulator and a realistic representation of the virtual hand.

Consequently, the resulting technical effects are likewise not separable: it is necessary to combine the control of the robot by teleoperation with the correct overlay of a hand whose posture is life-like in order to create a perception of realism and naturalness of the actions observed and/or performed and to ensure, therefore, the involvement and personification of both users in the remote shared context of interaction.

Furthermore, the distinction between the user who controls the robot and the user who observes the manipulation of his or her own environment is an important feature of the invention.

The second user, in fact, controls with his or her own movements the robot with which he or she does not share the working space, whilst the first user, spectator of the action, shares the physical space with the robotic manipulator, which is conveniently concealed and replaced with the avatar of the virtual hand of the first user. This is a key element for ensuring that the user who is spectator can perceive the environment in a natural and realistic manner, without visual obstacles due to the presence of the robot.

Naturally, without prejudice to the principle of the invention, the implementations and details of the embodiments thereof may vary widely with respect to what has been described and illustrated purely by way of non-limiting example, without for this reason going beyond the scope of protection of the present invention defined by the appended claims.

1-7. (canceled)

8. A system of physical interaction between two users in an augmented reality, the system of physical interaction comprising:
a display device equipped with a camera and a processing unit, adapted to be worn by a first user;
a manipulator device adapted to perform mechanical manipulation controlled by a second user;
wherein the first user is in an environment in which said manipulator device is present, the processing unit being configured to project, via the camera, to eyes of said first user, a stream of digital images representative of a fusion of at least one virtual image of augmented reality and at least one real image of the environment in which said first user is located, wherein the processing unit is configured to remove from said stream of digital images, during said mechanical manipulation, portions of the at least one real image corresponding to the manipulator device and replace the portions of the at least one real image with an image of a virtual hand of said second user.

9. The system of physical interaction according to claim 8, further comprising an object suitable for being picked up by the manipulator device and carried toward the first user.

10. The system of physical interaction according to claim 8, wherein the manipulator device includes a processing unit configured to receive position signals representative of position coordinates of the second user in a predetermined reference system, and configured to operate the manipulator device so as to reproduce a position of said second user.

11. The system of physical interaction according to claim 10, further comprising a haptic feedback device configured to be worn by the second user and configured to receive from the processing unit of the manipulator device at least one response signal representative of the manipulator device manifested during said mechanical manipulation.

12. A process of physical interaction between a first user and a second user in an augmented reality, the process comprising operations of:
providing a display device equipped with a camera and a processing unit, wherein the display device is configured to be worn by the first user;
providing a manipulator device configured to perform a mechanical manipulation controlled by a second user, wherein the display device is worn by the first user when the display device is in an environment with said manipulator device;
projecting towards eyes of the first user, by the processing unit via the camera, a stream of digital images representative of a fusion of at least one virtual image of augmented reality and at least one real image of the environment in which the first user is located;
removing, by the processing unit, from said stream of digital images, during said mechanical manipulation, portions of the at least one real image corresponding to the manipulator device and replacing the portions of the at least one real image with an image of a virtual hand of said second user.

13. The process of physical interaction according to claim 12, further comprising operations of receiving, from a processing unit of the manipulator device, position signals representative of position coordinates of the second user in a predetermined reference system and operating the manipulator device so as to reproduce a position of said second user.

14. The process of physical interaction according to claim 13, wherein the second user puts on a haptic feedback device, wherein the processing unit of the manipulator device is configured to send at least one response signal representative of the manipulator device manifested during said mechanical manipulation to the haptic feedback device.

15. The process of physical interaction according to claim 13, wherein the position of the second user is reproduced exactly.

16. The system of physical interaction according to claim 10, wherein the position of the second user is reproduced exactly.
